(19) United States
(12) Patent Application Publication
(10) Pub. No.: US 2014/0321856 A1
(43) Pub. Date: Oct. 30, 2014

(54) WAVELENGTH MULTIPLEXED TRANSMITTER OPTICAL MODULE

(71) Applicant: Sumitomo Electric Industries, Ltd., Osaka-shi (JP)

(72) Inventors: Tomoya Saeki, Yokohama-shi (JP); Munetaka Kurokawa, Yokohama-shi (JP); Kazunori Tanaka, Yokohama-shi (JP)

(21) Appl. No.: 14/362,099

(22) PCT Filed: Oct. 24, 2013
(86) PCT No.: PCT/JP2013/079476

§ 371 Date: May 30, 2014

(30) Foreign Application Priority Data
Oct. 26, 2012 (JP) 2012-237076
Oct. 26, 2012 (JP) 2012-237085

(51) Int. Cl. H04B 10/50; H04J 14/02

(52) U.S. Cl. CPC H04B 10/501; H04J 14/02
USPC 398/79; 398/201

(57) ABSTRACT

A transmitter optical module is disclosed. The transmitter optical module has optical sources each emitting optical beam with a specific wavelength different from others and lenses corresponding to the optical sources. The optical sources and the lenses are mounted on a carrier. The carrier provides grooves surrounding rectangular areas where each of the lenses is mounted.

### TECHNICAL FIELD

The present application relates to a wavelength multiplexed transmitter optical module.

### BACKGROUND ART

A wavelength multiplexed transmitter optical module provides a plurality of optical sources each outputting optical beam with a specific wavelength different from others. Each of optical beams is multiplexed by, for instance, a wavelength division multiplexing (WDM) filter and/or a polarization beam combiner (PBC). Such optical sources and optical parts are mounted on a carrier. A Japanese Patent Application published as JP-2011-066339A has disclosed one type of the wavelength multiplexed module where the optical sources and optical parts are arranged in an arrayed form.

An arrayed lens, such as disclosed in the patent above shown, is hard to align optically with the optical sources precisely, which results in a degraded optical coupling efficiency between them. While, discrete lenses often needs a substantial area to mount them, which is inconsistent with a small sized package for recently proposed in the field. In the closed assembled lenses, adhesives used to fix the lenses often interfere with neighbor adhesive, which prevents the lenses from aligning precisely.

### SUMMARY OF INVENTION

One aspect of the present application relates to a transmitter optical module. The transmitter optical module includes an optical source; a carrier; and an optical lens. The carrier mounts the optical source on a top surface thereof and the top surface provides an area surrounded by a groove. The optical lens, which is optically coupled with the optical source, is mounted on the area in the carrier by an adhesive resin. A feature of the optical transmitter is that the adhesive resin is dammed by the groove not to cross over the groove.

The transmitter optical module may further include other optical sources and other lenses, where they are also mounted on the carrier. The groove may have a lattice configuration and/or U-shaped configuration with an open side to form a plurality of rectangular areas each of which mounts the lens.

In a preferable embodiment of the transmitter optical module, the optical module provides four optical sources each including an LD and four collimating lenses each optically coupled with respective LDs. Each of the collimating lenses is mounted in the rectangular area demarcated by the groove having the lattice configuration or the U-shaped configuration. The adhesive resin to fix the collimating lens to the carrier extends only within the rectangular area not to exude from the area and to creep up the lens body.

### BRIEF DESCRIPTION OF DRAWINGS

The foregoing and other purposes, aspects and advantages will be better understood from the following detailed description of a preferred embodiment of the invention with reference to the drawings, in which:

FIG. 1 schematically illustrates a transmitter optical module of an embodiment;

FIG. 2 is a plan view of a carrier installed within the transmitter optical module shown in FIG. 1;

FIG. 3A shows a cross section of the carrier viewed from the optical axis of the lens, and FIG. 3B shows a cross section of the carrier viewed from a direction perpendicular to the optical axis;

FIG. 4 schematically illustrates a transmitter optical module of another embodiment;

FIGS. 5A to 5C are a perspective view, a front view, and a side view of an optical lens according to the first example;

FIGS. 6A to 6C are a perspective view, a front view, and a side view of another optical lens according to the second example;

FIGS. 7A to 7C are a perspective view, a front view, and a side view of still another optical lens according to the third example;

FIGS. 8A to 8C are a perspective view, a front view, and a side view of still another optical lens according to the fourth example;

FIG. 9 is a plan view of another carrier installed within the transmitter optical module shown in FIG. 1;

FIGS. 10A to 10F show conditions of the lens and the adhesive resin where the groove provided on the carrier has a lattice configuration; and

FIGS. 11A to 11F show conditions of the lens and the adhesive resin in a case that the groove has a U-shaped configuration.

### DESCRIPTION OF EMBODIMENTS

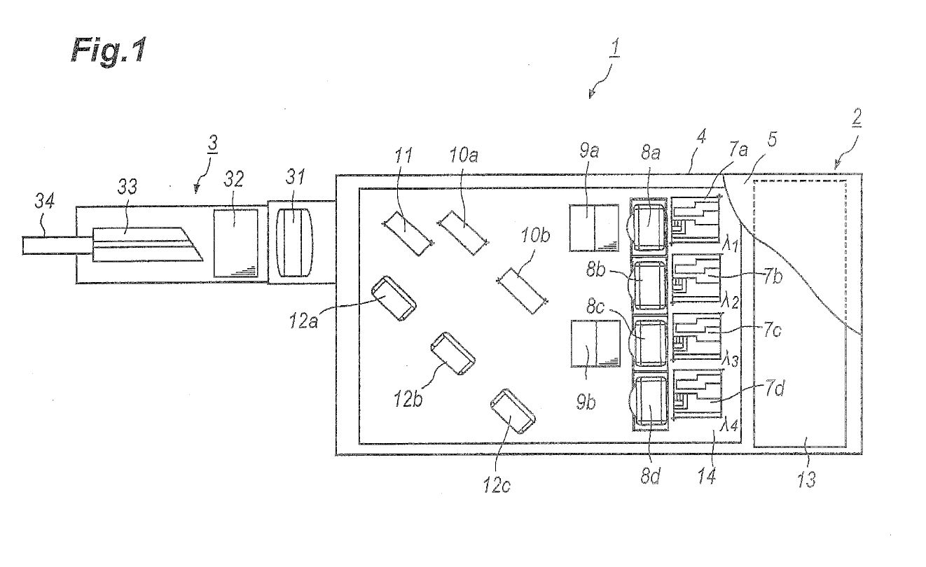

FIG. 1 schematically illustrates a WDM transmitter optical module according to one of embodiments of the invention. The transmitter optical module 1 comprises a body portion 2 and an optical coupling portion 3 to couple the body portion 2 with an external fiber. The body portion 2 has a housing comprised of a box 4 and a ceiling 5. The coupling portion 3 is assembled with one of walls of the box 4. Provided between the coupling portion 3 and the box 4 is a window, which is not explicitly shown in the figures, to seal a space formed by the box 4 and the ceiling 5 hermetically, into which electrical and optical components are installed.

The box 4 installs a plurality of optical sources, 7a to 7d, and some optical components therein, where the optical components include a plurality of lenses, 8a to 8d, polarization rotators, 9a and 9b, WDM filters, 10a and 10b, a polarization beam combiner (PBC) 11, and mirrors, 12a to 12c. The box 4 sometimes installs a circuit 13 to drive optical sources, 7a to 7d, and a carrier 14 to mount and fix the optical sources, 7a to 7d, and the optical components thereon.

The optical sources, 7a to 7d, which are laterally arranged in one array, output optical beams each having a specific wavelength different from others. In the explanation below, the wavelengths of optical beams are assumed to be λ₁ to λ₄, following the standard of the local area network wavelength division multiplexing (LAN-WDM). For instance, each of optical beams has a center wavelength of 1295.56 nm, 1300.56 nm, 1300.05 nm, and 1304.58 nm.

The lenses, 8a to 8d, each of which corresponds to the optical sources, 7a to 7d, convert the optical beams output from the optical sources, 7a to 7d, into collimated beams. In the present embodiment, the lenses, 8a to 8d, have an arrangement same to each other. The polarization rotators, 9a and 9b, which are placed in the downstream of the first and third optical source, 7a and 7c, rotate the polarization of the optical beams by 90°.

One of the WDM filters 10a, which is placed in the downstream of the first polarization rotator 9a, transmits the optical beam with the wavelength of λ₁ selectively and reflects another optical beam with the wavelength of λ₃ selectively. The other WDM filter 10b, which is placed in the downstream of the second lens 8b, transmits the optical beam with the wavelength of λ₂; while, reflects another optical beam with the wavelength of λ₄ selectively.

The first mirror 12a, which is placed in the downstream of the second WDM filter 10b, reflects the optical beams with the wavelengths of λ₂ and λ₄, which are output from the second WDM filter 10b, toward the PBC 11. The second mirror 12b placed in the downstream of the second polarization rotator 9b reflects the optical beam with the wavelength of λ₃. The third mirror 12c placed in the downstream of the fourth lens 8d reflects the optical beam with the wavelength of λ₄.

The PBC 11, which is placed in the downstream of the first WDM filter 10a, transmits the optical beam from the first WDM filter 10a, which includes the optical beam coming from the first polarization rotator 9a and that from the second polarization rotator 9b; while, reflects the optical beam coming from the mirror 12a, which includes the optical beam coming from the second lens 8b and that from the fourth lens 8d. The former two optical beams have the wavelengths of λ₁ and λ₃, while, the latter two optical beams reflected by the PBC 11 have the wavelengths of λ₂ and λ₄. Note that the former two optical beams have the polarization different by 90° from the polarization of the latter two beams, because the former beams pass respective polarization rotators, 9a and 9b.

Thus, the transmitter optical module 1 outputs an optical beam multiplexing four optical beams output from the optical sources, 7a to 7d, depending on the wavelengths thereof through the window provided in the front wall of the box 4. The wavelength multiplexed optical beam is focused by the other lens 31 onto a tip of the external optical fiber 34 through the polarization independent isolator 32.

The circuit 13 to drive the optical sources, 7a to 7d, is usually installed within the box 4, specifically, fixed on a bottom of the box 4; while, the carrier 14, onto which the optical sources, 7a to 7d, and optical components are mounted, is installed on a top of the thermo-electric controller (TEC), which is not explicitly shown in the figures.

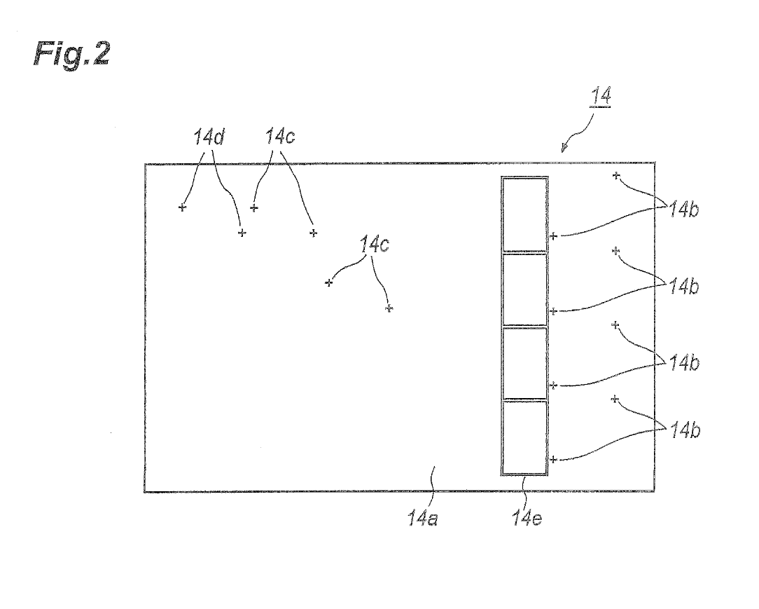

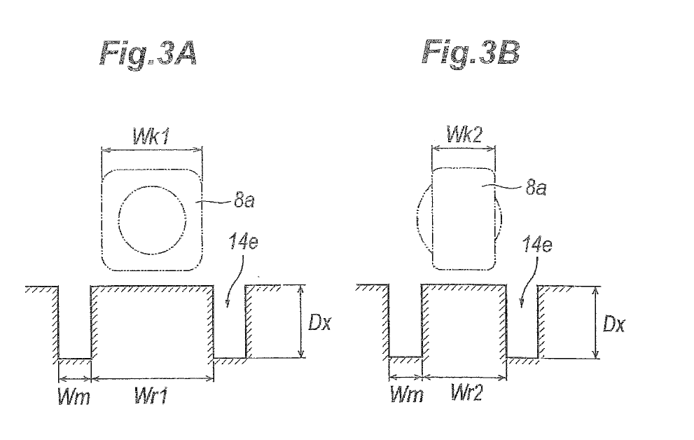

Thus, the transmitter optical module 1 described above has a feature in the carrier 14 thereof to mount the lenses, 8a to 8d. FIGS. 2 to 3B show the feature of the carrier 14 in detail, where FIGS. 3A and 3B magnify an area of the carrier 14 on which the optical lens is mounted.

FIG. 2 is a plan view of the carrier 14. The carrier 14 provides, on a top surface 14a thereof, alignment marks 14b to identify the position to mount the optical sources, 7a to 7d; other marks 14c to align the WDM filters, 10a and 10b; and alignment marks 14d to position the PBC 11. The top surface 14a further provides grooves 14e with the lattice configuration each surrounding respective areas for the optical lenses, 8a to 8d. That is, respective optical lenses, 8a to 8d, are surrounded by the groove 14e when they are mounted within respective areas.

The grooves 14e formed in rectangles have a function to prevent adhesive resin for fixing the optical lenses, 8a to 8d, from being oozed out from the area because the adhesive resin dripped in the area forms a fillet to the optical lenses, 8a to 8d. Thus, the adhesive resin dripped in the neighbor areas dose not interfere the fixing of the optical lens within the area under consideration.

Describing further specifically, the adhesive resin dripped onto the area surrounded by the groove 14e extends within the area to the edge of the groove but dammed at the edge by the surface tension thereof. When an adequate adhesive resin is dripped onto the area surrounded by the groove 14e, a gap between the bottom of the optical lens, 8a to 8d, and the top surface 14a of the carrier is filled with the adhesive resin with a constant thickness, which not only brings the stabilized adhesive strength but suppresses an uneven stress caused in the adhesive resin during the hardening thereof. Thus, the optical lenses, 8a to 8d, may be placed on their designed positions with a displacement less than 1 μm.

The groove 14e, or the area surrounded by the groove 14e preferably has a size such that a portion not covered by the lens is substantially equal to or greater than a portion covered by the lens, 8a to 8d. Specifically, referring to FIGS. 3A and 3B, a lateral width Wr1 between the grooves 14e is 1.1 to 1.5 times broader than a lateral dimension of the lens 8a, and a longitudinal width Wr2 between grooves 14e is 1.1 to 1.5 times greater than a longitudinal dimension, namely, thickness of the lens 8a. The area having such dimensions suppresses the deficient formation of the fillet by the adhesive resin and the insufficient adhesive strength between the optical lens 8a and the top surface 14a of the carrier 14. A width Wm of the groove 14e is preferably 25 to 100 μm and a depth Dx is greater than 20 μm for the lens with a planar dimension of 1.1×0.6 mm.

Conventional techniques tend to form a groove with a narrower width and a V-shaped cross section. The grooves 14e of the embodiment of the present application do not have a V-shaped cross section with a wall making an angle of 30 to 60° against the top surface 14a of the carrier 14 but have an angle of 70 to 90° against thereto. Such a groove with the sharp angle easily dams the adhesive resin at the edge of the groove due to the surface tension thereof. Thus, the adhesive resin does not extend over the groove 14e to the neighbor area.

The embodiments shown in the figures provide the carrier 14 made of aluminum nitride (AlN), silicon (Si), silica (SiO₂), alloy of iron, nickel, and cobalt, which is often called as Kovar, and so on, coated with gold (Au) on the top surface 14a thereof. The adhesive resin preferably has thixotropic characteristic. Specifically, the adhesive resin preferably has the thixotropy greater than 1.0 calculated by a ratio of two viscosities measured at 50 and 5 rpm by the rotational viscometer. A resin containing minute particles made of at least one of calcium carbonate (Ca(CO)₃), silica, aluminum and so on, with a size of 10 to 50 μm as fillers is preferably usable for the adhesive resin to fix the lenses, 8a to 8d, onto the carrier 14. However, minute particles with a size less than 10 μm but greater than 0.05 μm show a function substantially same as those mentioned above. Further specifically, an adhesive resin made of primarily epoxy resin curable with ultraviolet rays and smaller contraction coefficient is most preferable.

Next, a process to assemble the wavelength multiplexing transmitter optical module of the embodiments will be described as referring FIGS. 1 and 2. The process first sets the optical sources, 7a to 7d, on the carrier 14 by referring to alignment marks 14b provided on the top surface 14a of the carrier 14, then, fixes them to the carrier 14. Next, dripping the adhesive resin by a predetermined amount in an area surrounded by the grooves 14e where one of lenses 8a to 8d is to be fixed. Then, the optical source 7a is practically activated by providing a current thereto, the lens 8a is aligned in directions of X, Y, Z, θ, and (φ) on the dripped adhesive resin as an optical beam output from the optical lens 8a becomes a preconditioned collimated beam. After the alignment of the lens 8a, the adhesive resin is solidified by irradiating the resin with ultraviolet rays. During the solidification of the adhesive resin, the lens 8a is often floated from the carrier 14. The optical alignment for the lens is iterated for the other lenses, 8b to 8d.

The process next temporarily fixes the polarization rotators, 9a and 9b, to be set in front of two optical sources, 7a and 7c. The fixation of the polarization rotators, 9a and 9b, is only by referring to alignment marks provided on the top surface 14a of the carrier 14 and using an ultraviolet curable resin, and/or, thermo-curable resin. Similarly, two WDM filters, 10a and 10b, and the PBC 11 are also fixed on the carrier 14 only by referring to alignment marks, 14c and 14d.

Then, the carrier 14 on which the optical sources, 7a to 7d, and optical lenses, 8a to 8d, are mounted, is installed within the box 4 such that the monitoring apparatus attached to the front wall of the box 4 detects a maximum optical power through the window by practically activating the optical sources, 7a to 7d. The monitoring apparatus generally includes a single mode fiber with a collimating lens to guide an optical beam from the window, and the apparatus itself is mounted on a stage. The box 4 installs a driver 13 to drive the optical sources, 7a to 7d, in advance to the optical alignment descried above. After the fixation of the carrier 14 within the box 4, the optical sources, 7a to 7d, are wired to the driver 13.

Next, the mirrors, 12a to 12c, are fixed on the carrier 14. The mirrors, 12a to 12c, are optically aligned in an angle and position thereof so as to maximize the detected optical power by the monitoring apparatus described above. After the alignment, the mirrors, 12a to 12c, are permanently fixed by hardening the thermo-curable resin and/or UV-curable resin. Finally, an atmosphere within the box 4 is substituted by dry nitrogen, and the ceiling 5 is welded in the nitrogen atmosphere to seal the optical sources, 7a to 7d, and optical components in the box 4 hermetically.

The coupling portion 3 is welded to the box 4 by using the YAG laser beam. The optical alignment of the coupling portion 3 is carried out such that the maximum optical power is detected through the optical fiber 34 secured within the coupling portion 3 as the optical source 7a is practically activated. Thus, the assembly of the transmitter optical module 1 is completed.

One of alternate processes is that optical components except for the mirrors, 12a to 12c, are mounted on the carrier 14, then, the optical sources, 7a to 7d, are aligned as monitoring the beam profile output from respective optical sources, 7a to 7d, by an general beam profiler. The embodiment described above, the carrier 14 provides the grooves 14e surrounding only the optical lenses, 8a to 8d; however, the carrier 14 preferably provides grooves surrounding the mirrors, 12a to 12c, and other optical components mounted on the carrier 14.

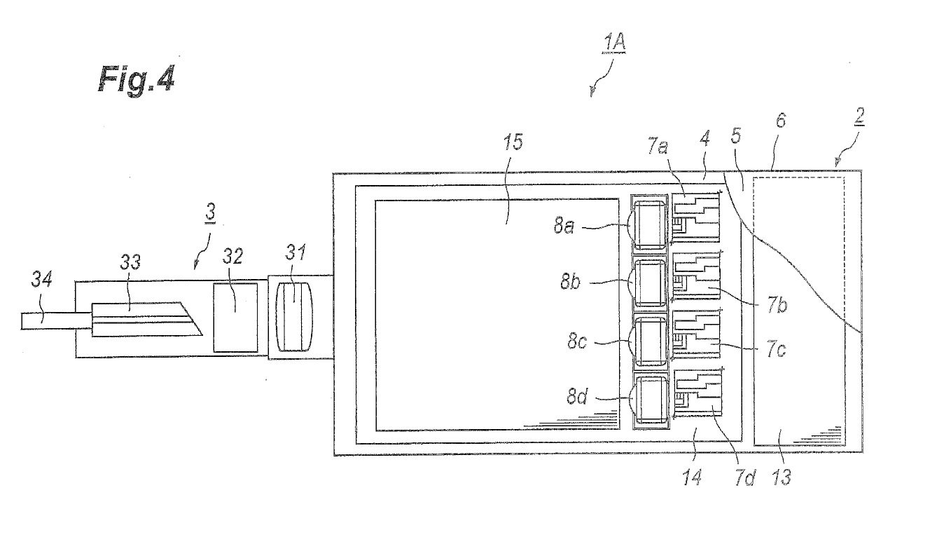

FIG. 4 schematically illustrates another transmitter optical module 1A. The aforementioned optical module 1 multiplexes optical signals each having wavelengths of λ₁ to λ₄ by the polarization rotator, 9a and 9b, WDM filters, 10a and 10b, and the PBC 11. The transmitter optical module 1A shown in FIG. 4 multiplexes the optical signals by a planar light circuit (PLC) 15, or a planar optical waveguide so as to concentrate the multiplexed optical signals on the concentrating lens 31.

An assembly of the transmitter optical module 1A shown in FIG. 4 is same as those described above until the optical lenses, 8a to 8d, are fixed in front of respective optical sources, 7a to 7d. After the alignment of the optical lenses, 8a to 8d, an electrically conductive resin, or a conductive paste fixes the PLC 15 on the carrier 14 so as to maximize the optical coupling efficiency between the PLC 15 and the single mode fiber 34 in the monitoring apparatus. The electrically conductive resin, or the paste, is cured by a thermal procedure.

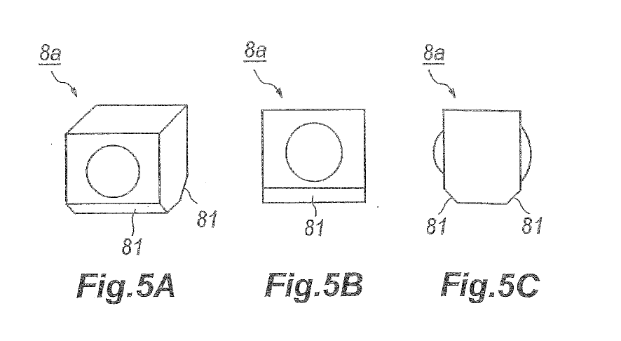

As described, the transmitter optical module 1 provides a plurality of optical sources, 7a to 7d, and collimating lenses, 8a to 8d, each placed in front of respective optical sources, 7a to 7d. Other embodiments of the present application relate to an outer appearance of the collimating lenses, 8a to 8d. FIGS. 5A to 5C schematically illustrates the collimating lenses, 8a to 8d, installed within the transmitter optical modules, 1 and 1A, where FIG. 5A is a perspective view, FIG. 5B is a front view, while, FIG. 5C is a side view of the lens 8a. FIGS. 5A to 5C only illustrate one lens, but the transmitter optical modules, 1 and 1A, install four lenses, 8a to 8d.

As shown in FIGS. 5A to 5C, the collimating lens 8a has a rectangular shape with chamfered edges 81 in the bottom surface facing the carrier 14. The chamfered edges 81 may suppress the adhesive resin from oozing out from a gap between the optical lens 8a and the carrier 14 and extending to an area of the neighbor lens. As described, other collimating lenses, 8b to 8d, have the outer shape same as that of the first optical lens 8a. Accordingly, the adhesive resin to fix respective collimating lenses, 8a to 8d, does not interfere, and the collimating lenses, 8a to 8d, are precisely aligned and fixed on the carrier 14.

Also, because the chamfered edges 81 are filled with adhesive resins, which reinforces the adhesive strength; the collimating lenses, 8a to 8d, thus fixed on the carrier 14 show higher share strength. When the optical lenses, 8a to 8d, have dimensions of 1.1 mm width and 0.6 mm thickness, the chamfered edges 81 preferably have a depth of about 50 μm.

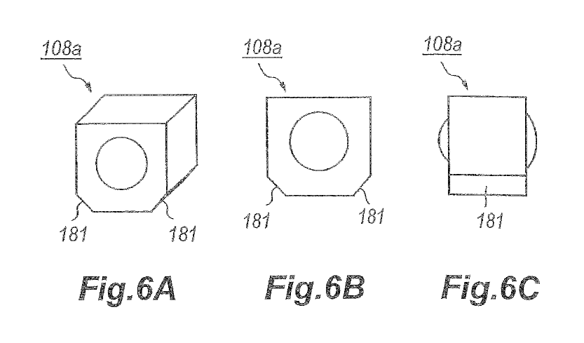

The collimating lenses, 8a to 8d, in a shape thereof are not restricted to those shown in FIGS. 5A to 5C; FIGS. 6A to 8C show other shapes of the optical lenses, 8a to 8d, where FIGS. 6A, 7A and 8A are perspective views, FIGS. 6B, 7B and 8B are front views; and FIGS. 6C, 7C, and 8C are plan views of the collimating lenses. FIGS. 6A to 8C show one of lenses installed within the box 4; but, others within the box 4 have a shape same as those shown in FIGS. 6A to 8C.

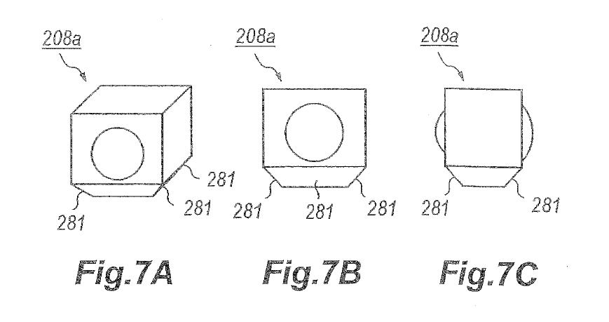

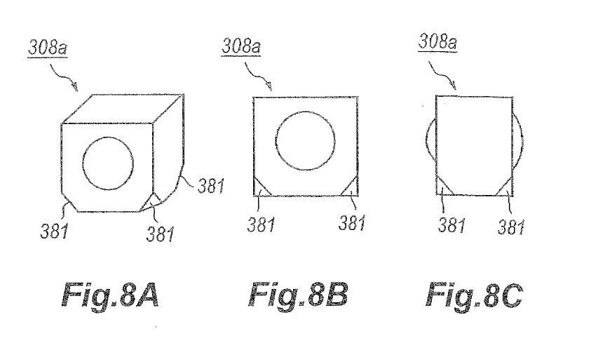

A collimating lens 108a shown in FIGS. 6A to 6C has a shape substantially rectangular with chamfered two edges 181 in the bottom of the lens 108a extending substantially in parallel with the optical axis of the lens. Another collimating lens 208a shown in FIGS. 7A to 7C has a shape also substantially rectangular but having chamfered four edges 281 in the bottom surface thereof. That is, the chamfered two edges extend in parallel to the optical axis, while, the other two edges extend in perpendicular to the optical axis. Still another collimating lens 308a shown in FIGS. 8A to 8C, which is also a rectangular, but in the bottom surface thereof has four chamfered corners 381.

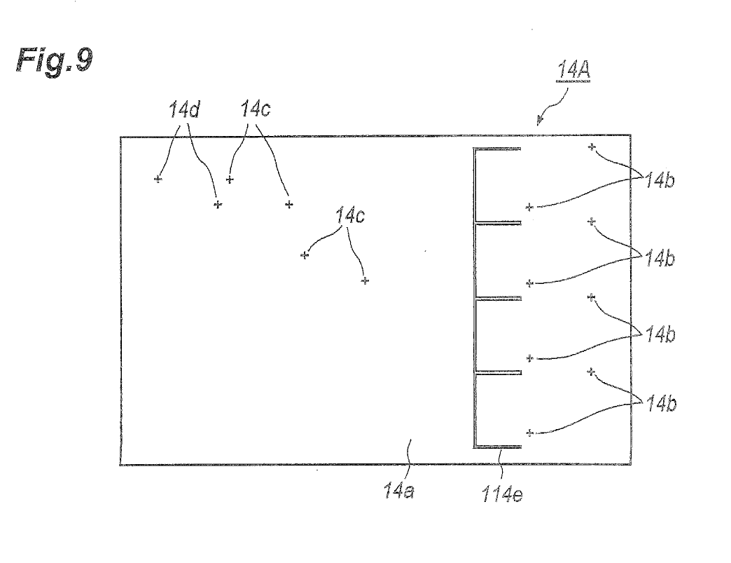

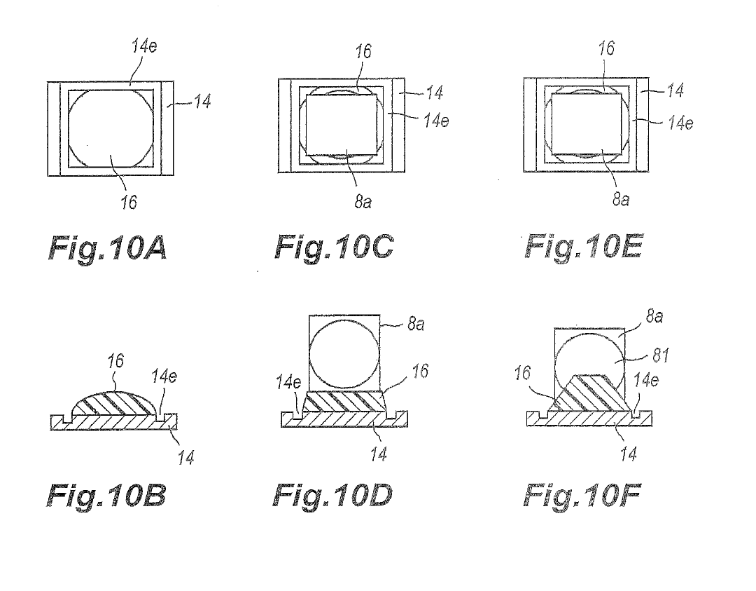

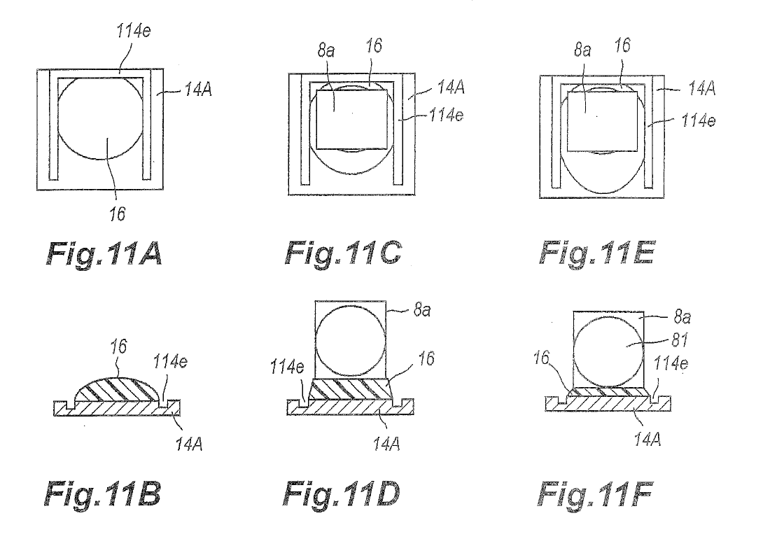

FIG. 9 is a plan view showing another example of the carrier 14A; while, FIGS. 10 and 11 compare an advantage of the modified carrier 14A shown in FIG. 9, where FIGS. 10A, 10C, 10E, 11A, 11C and 11E are plan views and FIGS. 10B, 10D, 10F, 11B, 11D, and 11F are front view when the carrier 14A mounts the lens 8a with the adhesive resin 16.

The carrier 14 shown in FIG. 1 provides grooves 14e with the box shape forming a closed loop; while, the carrier 14A of the present embodiment also provides the groove 114e but has a U-shaped configuration. That is, three grooves surround the area to mount the collimating lens 8a but last edge to form the area is free from the groove.

In the carrier 14 shown in FIG. 1, when the carrier 14 mounts the collimating lens 8a, an adhesive resin 16 is first dripped in the area to mount the collimating lens 8a, as shown in FIGS. 10A and 10B; then the collimating lens 8a is optically aligned. In this process, when the optical source 7a in the horizontal level thereof substantially follows the designed level, the center of the lens 8a coincides with that of the optical source 7a, namely, an emitting point of the LD. Then, as shown in FIGS. 10C and 10D, the adhesive resin 16 causes no problems. However, when the horizontal level of the optical source 7a is lower than the designed one due to, for instance, dispersion of physical dimensions thereof; a surplus adhesive resin 16 is oozed out, dammed by the groove 14 and creeps up the lens 8a, which occasionally covers a portion of the lens body 81.

On the other hand, in the process to mount the lens 8a on the modified carrier 14A, the adhesive resin 16 is first dripped in the area surrounded by the groove 114e same as those shown in FIGS. 10A and 10B. Then, placing the lens 8a on the adhesive resin 16, the adhesive resin 16 oozes out toward the edge where no groove is formed. Even when the level of the optical source 7a is lowered, the surplus resin 16 is oozed out toward the edge where no groove is formed; the surplus resin does not swell up the lens body 81. Thus, the modified carrier 14A with the U-shaped groove 114e effectively prevents the surplus resin from creeping up to the lens body 81.

The open edge of the area is preferably formed in a side where no optical components are placed, or a distance to a next component is widest. In an example shown in FIG. 9, the groove 114e is preferably formed in areas between the collimating lenses, 8a to 8d, and the polarization rotators, 9a and 9b, so as to be opened in the side facing the optical sources, 7a to 7d.

Next, a process to mount the collimating lens 8a on the carrier 14A shown in FIG. 9 will be described. The process assumes that, referring to FIG. 3, the physical dimensions of the collimating lens 8a of 0.6 mm in width Wk1, 0.55 mm in thickness Wk2, and 1.0 mm in height, respectively. The process first drips an adhesive resin 16 within an area surrounded by three grooves 114e by a preset amount with, for instance, a pipette. The dripped resin 16 is dammed at the edges of the groove 114e due to the surface extension, and stays there with a thickness of about 100 μm.

Placing down the collimating lens 8a, which is held by a vacuum collet, into a center of the adhesive resin 16, and aligning the lens 8a such that the optical output power detected through the external fiber becomes a maximum, the position of the collimating lens 8a is determined. The center of the collimating lens 8a ideally coincides with the emitting spot of the optical source 7a, namely, the LD 7a. The adhesive resin 16 has a thickness of 30 μm at least but 80 μm at most after the dripping, because the collimating lens 8a is able to be aligned without interfering the carrier even the horizontal level of the LD 7a shows scattering, which is ±30 μm in the present example. That is, the adhesive resin 16 with the thickness of 80 μm leaves a tolerance at least 50 μm for the vertical alignment.

Even when the level of the LD 7a is shifted from the designed position by 30 μm, namely, 80 μm apart from the top of the carrier 14A, the adhesive resin 16 with a thickness of 80 μm is enough for covering the whole bottom of the collimating lens 8a with the resin. Oppositely, when the level of the LD 7a is lowered by 30 μm from the designed level, the surplus resin 16 flows outside of the area through a portion not providing the groove 114e, which effectively prevents the adhesive resin 16 from creeping up the lens body to restrict an optically effective area of the collimating lens 8a and/or oozing out to neighbor areas across over the groove 114e.

The groove 114e of the present embodiment has dimensions of 80±50 μm in depth and 80±50 μm width; while, the area to which the collimating lens 8a is mounted has dimensions of 0.66 to 0.99 mm, which means that the pitch between the LDs is 0.75 mm, the width of the groove 114e is 80 μm, and the width of the area is 0.67 mm. Also, the area has a room between the side of the collimating lens 8a and the edge of the groove 114e is wider than 1 mm, while, a space from the front of the lens 8a to the groove 114e is preferably greater than 0.25 mm.

The groove, 14e and/or 114e, is preferably formed by sandblasting for the carrier 14 made of, for example, aluminum nitride (AlN), aluminum (Al₂O₃), and so on. The embodiments thus described concentrate on how to mount a collimating lens, 8a to 8d, on the carrier 14. That is, the groove, 14e and 114e, is prepared only to surround the collimating lens therein. However, other grooves are preferably prepared for surrounding other components such as the wavelength selective filter 10, the PBC 11, and the mirror 12, to prevent the adhesive resin from oozing out from the area.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

1. A transmitter optical module, comprising:
an optical source;
a carrier configured to mount the optical source on a top surface thereof, the carrier providing an area surrounded by a groove formed in the top surface of the carrier; and
an optical lens optically coupled with the optical source, the optical lens being mounted on the area with an adhesive resin.

2. The transmitter optical module of claim 1,
wherein the adhesive resin is dammed by the groove not to cross over the groove.

3. The transmitter optical module of claim 1,
wherein the groove has a wall making an angle of 70° to 90° with respect to the top surface of the carrier.

4. The transmitter optical module of claim 3,
wherein the groove has the wall substantially perpendicular to the top surface of the carrier.

5. The transmitter optical module of claim 1,
wherein the area surrounded by the groove is wider than a bottom surface of the optical lens, the bottom surface facing and being in contact with the top surface of the carrier.

6. The transmitter optical module of claim 5,
wherein the area surrounded by the groove is 1.1 to 1.5 times broader than the bottom surface of the lens.

7. The transmitter optical module of claim 1,
wherein the groove has a lattice configuration.

8. The transmitter optical module of claim 1,
wherein the groove has a U-shaped configuration.

9. The transmitter optical module of claim 1,
wherein the adhesive resin is a type of ultraviolet curable resin having thixotropy thereof greater than 1.0 calculated by a ratio of two viscosities measured at 50 and 5 rpm by a rotational viscometer.

10. The transmitter optical module of claim 1,
further including other optical sources and other optical lenses each corresponding to respective optical sources, each of the optical sources and the optical lenses being mounted on the carrier in an array,
wherein the carrier further provides grooves corresponding to respective lenses and surrounding respective areas each for mounting the lens by an adhesive resin.

11. The transmitter optical module of claim 10,
wherein each of the grooves has a wall substantially perpendicular to the top surface of the carrier.

12. The transmitter optical module of claim 10,
wherein each of the grooves has a lattice configuration.

13. The transmitter optical module of claim 10,
wherein each of the grooves has a U-shaped configuration.

14. The transmitter optical module of claim 13,
wherein the adhesive resin for mounting respective lenses within the area extends toward an open side of the U-shaped groove.

15. A wavelength division multiplexing (WDM) transmitter module, comprising:
four semiconductor laser diodes (LD) each emitting an optical beam with a specific wavelength different from others;
four optical lenses each optically coupled with respective LDs to collimate the optical beam emitted from the LD; and
a carrier including a top surface for mounting the LDs and the optical lenses thereon by an ultraviolet curable resin,
wherein the carrier provides a plurality of grooves each surrounding an area for mounting respective optical lenses, each of the grooves having a wall substantially perpendicular to the top surface, and the ultraviolet curable resin is dammed by the groove to extend only within the area.

16. The WDM transmitter module of claim 15,
wherein each of the grooves has a lattice configuration to surround the area fully.

17. The WDM transmitter module of claim 15,
wherein each of the grooves has a U-shaped configuration with an open side not provided with the groove, and
wherein the ultraviolet curable resin exudes out toward the open side of the area surrounded by the U-shaped groove.
